(19) United States
(12) Patent Application Publication
(10) Pub. No.: US 2018/0336579 A1
(43) Pub. Date: Nov. 22, 2018

(54) SYSTEMS AND METHODS FOR SCHEDULING DATACENTER BUILDOUTS

(71) Applicant: Microsoft Technology Licensing, LLC, Redmond, WA (US)

(72) Inventors: David Thomas GAUTHIER, Seattle, WA (US); Ricardo Gouvêa BIANCHINI, Bellevue, WA (US); Ioannis MANOUSAKIS, New York, NY (US)

(21) Appl. No.: 15/599,180

(22) Filed: May 18, 2017

(51) Int. Cl. G06Q 30/02; G06Q 10/06; G06Q 50/08

(52) U.S. Cl. CPC G06Q 30/0202; G06Q 50/08; G06Q 10/067; G06Q 10/0635

(57) ABSTRACT

A system estimates a future demand for resources over a first time period to build a datacenter. The resources include construction resources to construct the datacenter and computing resources for the datacenter. The system generates, based on inputs including the future demand, a first schedule of resources to build a first stage of the datacenter over the first time period. The first schedule includes fewer resources than an amount of resources capable of fulfilling the future demand. The system determines a probability of the first schedule not fulfilling the future demand and determines a risk associated with the first schedule based on the probability. The system identifies procedures to employ to mitigate the risk, including oversubscribing resources in the first schedule, lending a portion of the future demand to a peer datacenter, and leasing an additional datacenter, where the first schedule and the procedures minimize cost of building the datacenter.

### FIELD

The present disclosure relates generally to cloud computing systems and more particularly to systems and methods for scheduling datacenter buildouts.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Deploying large-scale datacenters that host multiple tenants involves consideration of a multitude of trade-offs and constraints. Planning and designing datacenters that will be deployed at multiple locations over the long term can be a challenging task. Further, the uncertainties associated with future demand for resources in the datacenters can make the planning and designing of the datacenters more difficult.

### SUMMARY

A system comprises a processor and machine readable instructions stored on a tangible machine readable medium. When executed by the processor, the machine readable instructions configure the processor to estimate, using a model, a future demand for resources over a period of time to build a datacenter, the resources comprising construction resources including land, power, and network infrastructure to construct the datacenter and computing resources including computing devices for the datacenter, and the period of time including a first time period followed by a second time period. The machine readable instructions configure the processor to generate, using the model, based on inputs including the future demand, a first schedule of resources to build a first stage of the datacenter over the first time period, the first schedule including fewer resources than an amount of resources capable of fulfilling the future demand. The machine readable instructions configure the processor to determine, using the model, a probability of the first schedule not fulfilling the future demand; and to determine, using the model, a risk associated with the first schedule based on the probability. The machine readable instructions configure the processor to identify one or more procedures to employ to mitigate the risk, the procedures including oversubscribing resources in the first schedule, lending a portion of the future demand to a peer datacenter, and leasing an additional datacenter. The machine readable instructions configure the processor to generate, based on the first schedule, a second schedule of resources to build a second stage of the datacenter over the second time period, the second schedule being an average of a plurality of schedules of resources generated for different percentages of the future demand using the model. The machine readable instructions configure the processor to modify the second schedule during the first time period based on demand information discovered while building the first stage of the datacenter during the first time period to minimize cost of building the datacenter.

In other features, the machine readable instructions configure the processor to minimize the cost of building the datacenter by minimizing capital costs, depreciation costs, operating costs associated with building the datacenter according to the first schedule, the modified second schedule, and the one or more procedures to mitigate the risk.

In other features, the machine readable instructions configure the processor to adjust one or more of the first and second schedules to provide a recommendation for land acquisition and construction planning to minimize the cost of building the datacenter. The machine readable instructions configure the processor to generate a periodic schedule specifying amounts of resources to be deployed over sub-periods of the period of time while building the datacenter over the period of time.

In other features, the machine readable instructions configure the processor to determine, using the model, a second probability of the second schedule or the modified second schedule not fulfilling the future demand. The machine readable instructions configure the processor to determine, using the model, a second risk associated with the second schedule or the modified second schedule based on the second probability. The machine readable instructions configure the processor to identify the one or more procedures to employ to mitigate the second risk.

In other features, the model is configured to estimate the future demand based on prediction of services to be provided to tenants by the datacenter, agreements with tenants, and opinions of business analysts and experts regarding the future demand.

In other features, the inputs include construction costs; lead times associated with land selection, design, and construction; energy efficiency; the future demand and risk selection; form factors for the datacenter; and constraints regarding land, power, and network infrastructure.

In still other features, a system comprises a processor and machine readable instructions stored on a tangible machine readable medium. When executed by the processor, the machine readable instructions configure the processor to estimate, using a model, a future demand for resources over a first time period to build a datacenter, the resources comprising construction resources including land, power, and network infrastructure to construct the datacenter and computing resources including computing devices for the datacenter. The machine readable instructions configure the processor to generate, using the model, based on inputs including the future demand, a first schedule of resources to build a first stage of the datacenter over the first time period, the first schedule including fewer resources than an amount of resources capable of fulfilling the future demand. The machine readable instructions configure the processor to determine, using the model, a probability of the first schedule not fulfilling the future demand; and to determine, using the model, a risk associated with the first schedule based on the probability. The machine readable instructions configure the processor to identify one or more procedures to employ to mitigate the risk, the procedures including oversubscribing resources in the first schedule, lending a portion of the future demand to a peer datacenter, and leasing an additional datacenter, where the first schedule and the one or more procedures minimize cost of building the datacenter.

In other features, the machine readable instructions configure the processor to generate, based on the first schedule, a second schedule of resources to build a second stage of the datacenter over a second time period following the first time period, the second schedule being an average of a plurality of schedules of resources generated for different percentages of the future demand using the model.

In other features, the machine readable instructions configure the processor to modify the second schedule during the first time period based on demand information discovered while building the first stage of the datacenter during the first time period.

In other features, the machine readable instructions configure the processor to adjust one or more of the first and second schedules to provide a recommendation for land acquisition and construction planning to minimize the cost of building the datacenter. The machine readable instructions configure the processor to generate a periodic schedule specifying amounts of resources to be deployed over sub-periods of the first and second time periods while building the datacenter over the first and second time periods.

In other features, the machine readable instructions configure the processor to determine, using the model, a second probability of the second schedule or the modified second schedule not fulfilling the future demand. The machine readable instructions configure the processor to determine, using the model, a second risk associated with the second schedule or the modified second schedule based on the second probability. The machine readable instructions configure the processor to identify the one or more procedures to employ to mitigate the second risk.

In other features, the model is configured to estimate the future demand based on prediction of services to be provided to tenants by the datacenter, agreements with tenants, and opinions of business analysts and experts regarding the future demand.

In other features, the inputs include construction costs; lead times associated with land selection, design, and construction; energy efficiency; the future demand and risk selection; form factors for the datacenter; and constraints regarding land, power, and network infrastructure.

In still other features, a method comprises estimating a future demand for resources over a first time period to build a datacenter, the resources comprising construction resources including land, power, and network infrastructure to construct the datacenter and computing resources including computing devices for the datacenter. The method further comprises generating based on inputs including the future demand, a first schedule of resources to build a first stage of the datacenter over the first time period, the first schedule including fewer resources than an amount of resources capable of fulfilling the future demand. The method further comprises determining a probability of the first schedule not fulfilling the future demand, and determining a risk associated with the first schedule based on the probability. The method further comprises identifying one or more procedures to employ to mitigate the risk, the procedures including oversubscribing resources in the first schedule, lending a portion of the future demand to a peer datacenter, and leasing an additional datacenter, where the first schedule and the one or more procedures minimize cost of building the datacenter.

In other features, the method further comprises generating, based on the first schedule, a second schedule of resources to build a second stage of the datacenter over a second time period following the first time period, the second schedule being an average of a plurality of schedules of resources generated for different percentages of the future demand.

In other features, the method further comprises modifying the second schedule during the first time period based on demand information discovered while building the first stage of the datacenter during the first time period.

In other features, the method further comprises adjusting one or more of the first and second schedules to provide a recommendation for land acquisition and construction planning to minimize the cost of building the datacenter. The method further comprises generating a periodic schedule specifying amounts of resources to be deployed over sub-periods of the first and second time periods while building the datacenter over the first and second time periods.

In other features, the method further comprises determining a second probability of the second schedule or the modified second schedule not fulfilling the future demand. The method further comprises determining a second risk associated with the second schedule or the modified second schedule based on the second probability. The method further comprises identifying the one or more procedures to employ to mitigate the second risk.

In other features, the method further comprises estimating the future demand based on prediction of services to be provided to tenants by the datacenter, agreements with tenants, and opinions of business analysts and experts regarding the future demand.

In other features, the inputs include construction costs; lead times associated with land selection, design, and construction; energy efficiency; the future demand and risk selection; form factors for the datacenter; and constraints regarding land, power, and network infrastructure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of a simplified example of a cloud computing system.

FIG. 2 is a functional block diagram of a simplified example of a datacenter shown in FIG. 1.

FIG. 3 is a functional block diagram of a simplified example of a cluster shown in FIG. 2.

FIG. 4 shows a shell of a datacenter including a deployed collocated space and an expansion to be subsequently added.

FIG. 5 shows an architecture and workflow of a system for building datacenters.

FIG. 6 is a graph of cost (in dollars per megawatt (MW)) versus size (in MW) for large- and medium-scale datacenters.

FIGS. 7A and 7B show demand fulfillment schedules for various risk management policies that can be used to address capacity shortfall in datacenters built with less capacities than worst case demand scenarios.

FIG. 8 shows an example of determining expected operational costs for datacenter deployments with different power usage effectiveness (PUEs).

FIG. 9 shows actual and total datacenter capacity with oversubscription potential that is selectively used to build datacenters with lower capacity and improve total costs and cash-flows when building datacenters.

FIG. 10 shows scheduling datacenter deployments with a two-stage approach.

FIG. 11 is a flowchart of a method for building datacenters.

FIG. 12 is a functional block diagram of a simplified example of a distributed network system.

FIG. 13 is a functional block diagram of a simplified example of a client device used in the distributed network system of FIG. 12.

FIG. 14 is a functional block diagram of a simplified example of a server used in the distributed network system of FIG. 12.

FIGS. 15A-15D show various symbols used throughout the present disclosure.

In the drawings, reference numbers may be reused to identify similar and/or identical elements.

### DETAILED DESCRIPTION

The present disclosure relates to systems and methods that include an optimization framework designed to discover an optimal or near-optimal deployment schedule for long-term planning of datacenters. A system according to the present disclosure described below in detail finds the most economical build and deployment schedule that satisfies the future demand by considering construction costs, lead times, depreciation, and numerous other design parameters. The system also takes into account the risk associated with its corresponding decisions and models an inventory of possible risk management actions such as leasing additional capacity and oversubscribing the existing datacenters. The system can assist in the decision making process by acting as a data-driven and reproducible scheduling recommendation framework. Throughout the present disclosure, the system is generally and broadly referred to as a system for building datacenters.

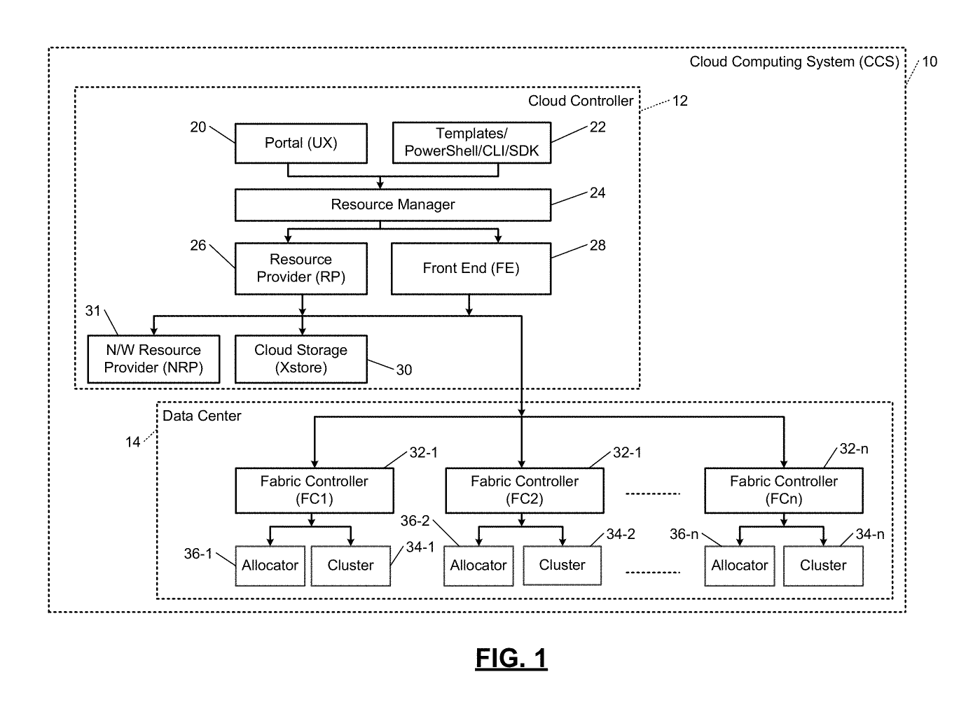

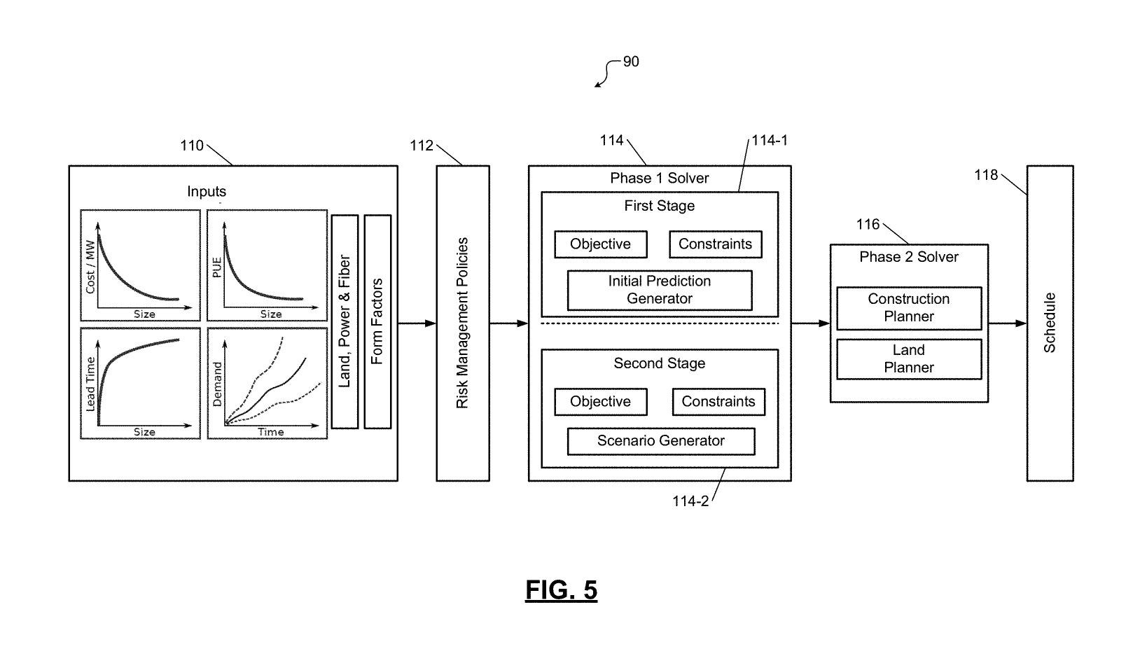

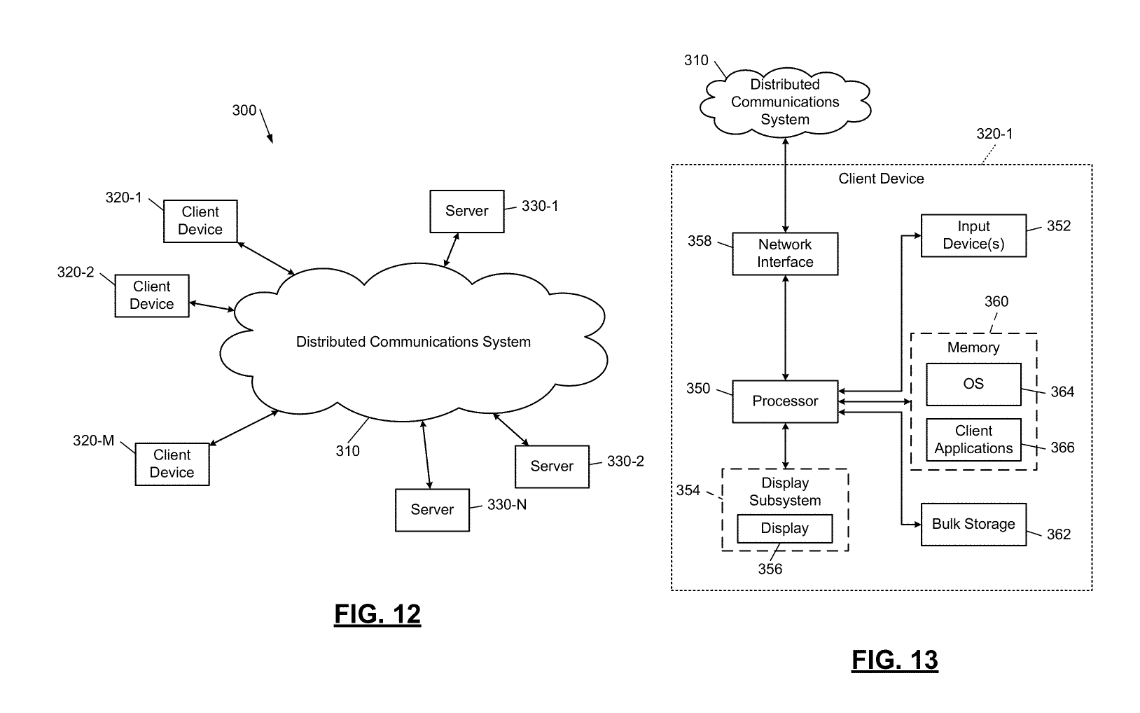

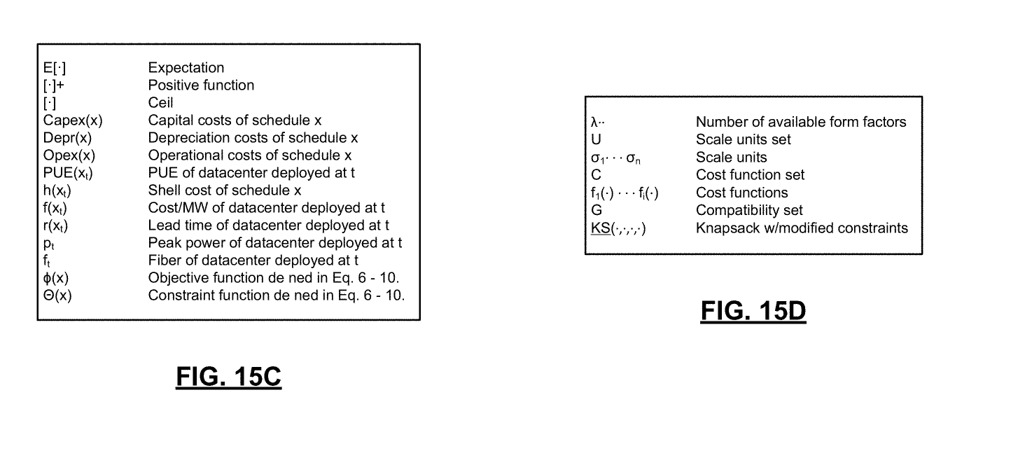

The present disclosure is organized as follows. First, an example of a cloud computing system including a datacenter is shown and described with reference to FIGS. 1-3. The systems and methods for building datacenters according to the present disclosure are described with reference to FIGS. 4-11. Thereafter, a simplified example of a distributed network system is described with reference to FIGS. 12-14, which can implement the cloud computing system shown in FIGS. 1-3, and which can implement the systems and methods for building datacenters shown in FIGS. 4-11. FIGS. 15A-15D list symbols used throughout the present disclosure.

FIG. 1 shows a simplistic example of a cloud computing system (CCS) 10. The cloud computing system 10 includes a cloud controller 12 and at least one datacenter 14. While only one datacenter 14 is shown for simplicity, the cloud controller 12 can interface with a plurality of datacenters. Further, while the datacenter 14 is shown as being local to the cloud controller 12, one or more datacenters may be geographically remote from the cloud controller 12, may be located in different geographic locations (e.g., in different time zones, different countries or continents, and so on), and may communicate with the cloud controller 12 via various networks.

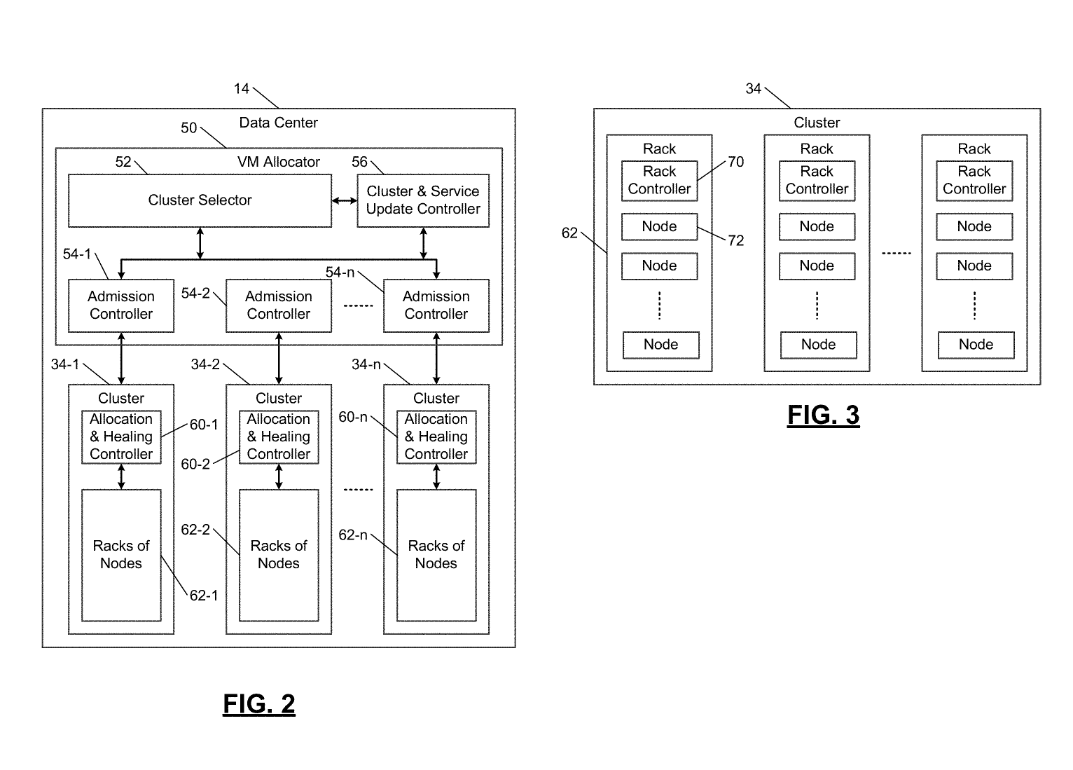

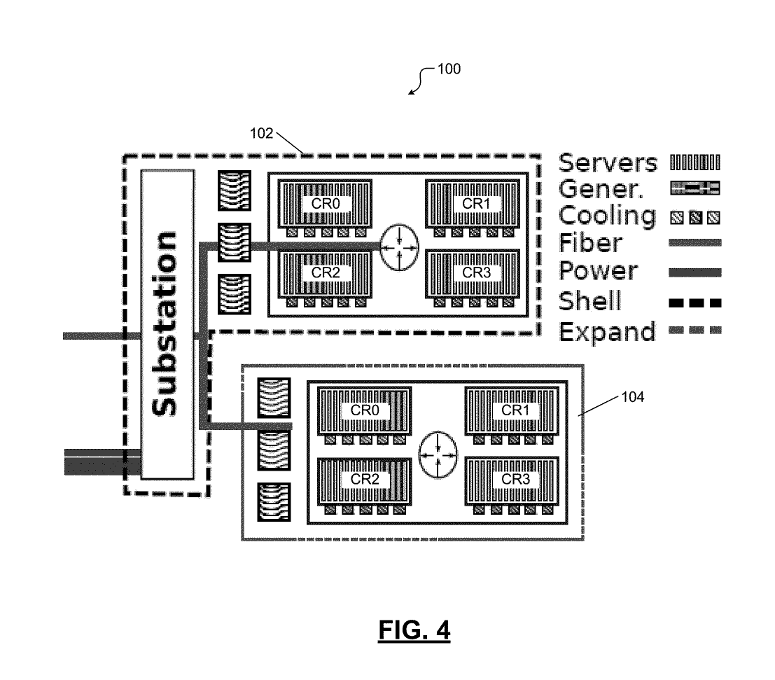

Each datacenter 14 includes a plurality of fabric controllers 32-1, 32-2, . . . , and 32-n (collectively fabric controllers 32) and corresponding clusters 34-1, 34-2, . . . , and 34-n (collectively clusters 34). Each fabric controller 32 controls a respective cluster 34. Each cluster 34 includes a plurality of racks (shown in FIGS. 2-3), and each rack includes a plurality of nodes (shown in FIG. 3), which are also called servers, hosts, or machines throughout the present disclosure. Each fabric controller 32 is associated with an allocator 36 that allocates resources within the cluster 34 for instances of customer services hosted on the cluster 34.

The cloud controller 12 includes a portal 20 and a software development kit (SDK) 22 that the customers can use to select resources and request service deployment. The cloud controller 12 further includes a cloud resource manager 24, a compute resource provider 26, and a front-end 28. The front-end 28 interfaces with the fabric controllers 32. The cloud resource manager 24 receives the customer selections and forwards the customer selections to the compute resource provider 26. The compute resource provider 26 generates a tenant model based on the customer selections. The compute resource provider 26 provisions resources to the customer services according to the tenant model generated based on the customer selections. The compute resource provider 26 provisions storage, networking, and computing resources by interfacing with a cloud storage (Xstore) 30, a network resource provider 31, and the fabric controllers 32.

FIG. 2 shows a simplistic example of the datacenter 14 shown in FIG. 1. The datacenter 14 includes a VM allocator 50 and the clusters 34. The VM allocator 50 includes a cluster selector 52 and a plurality of admission controllers 54-1, 54-2, and . . . , and 54-n (collectively admission controllers 54). Each admission controller 54 is associated with a corresponding cluster 34. Each cluster 34 includes an allocation and healing controller 60 (shown as allocation and healing controllers 60-1, 60-2, . . . , and 60-n; one allocation and healing controller per cluster) and one or more racks 62 of nodes (also called servers, hosts, or machines; and shown as racks 62-1, 62-2, . . . , and 62-n). The allocation and healing controller 60 can implement the VM allocator 36 of FIG. 1.

Allocating a VM can be a multilevel allocation operation. The VM allocator 50 first selects one of the clusters 34 in which to allocate a VM in association with the corresponding admission controller 54. After the VM allocator 50 selects one of the clusters 34 to allocate the VM, the allocation and healing controller 60 of the selected cluster 34 places the VM on one or more of the nodes in one or more of the racks 62 in the selected cluster 34 depending on the number of update and fault domains and other resources specified by the customer.

Based on VM activity in the clusters 34, a cluster and service update controller 56 provides updates to the cluster selector 52. For example, the VM activity may include activation and termination of one or more VM's in the clusters 34. The cluster and service update controller 56 may also provide updates to the cluster selector 52 regarding utilization of growth buffers due to service scale out and utilization of healing buffers due to node/rack failures.

FIG. 3 shows an example of the cluster 34 shown in FIGS. 1-2. Each cluster 34 includes the plurality of racks 62. Each rack 62 includes a rack controller 70 and a plurality of nodes 72. Each rack controller 70 includes a power controller that controls power allocation to the plurality of nodes 72 in the rack 62.

Datacenters 14 are expensive to plan and build. Current industry estimates place the cost bar between $7-14/Watt of critical information technology (IT) infrastructure for datacenters ranging from large to small scale. At the same time, computational demand is growing at a rate previously unheard of. This trend drives datacenter builds to sizes that may well exceed 128MW per facility and may be referred to as hyper-scale datacenters. Constructing such enormous facilities is a time demanding process, especially in locations with poor or no existing power and network infrastructure. The process is further delayed with the land selection process and the datacenter adaptation to the selected location. Although precise industry reports are unavailable due to highly confidential nature of corresponding data, it is estimated that it takes approximately two years to build large- to hyper-scale datacenters. Note that throughout the present disclosure, broadly speaking, building a datacenter (e.g., the datacenter 14 shown in FIG. 1) includes constructing the premises as well as installing the computing resources in the premises.

Often the guidelines that datacenter operators use for the build size (both the size of the premises and the amount of computing resources) are uncertain estimates for the future demand at each datacenter location. These estimates are often based on expert opinions, business analytics, and models derived from historical data for the surrounding region when available. Even with robust past data, these predictions can be uncertain since ultimately the task is reduced to predicting customer preferences.

To mitigate the uncertain demand, the datacenter operators are forced to deploy unnecessarily large builds which are scheduled according to predicted upper bounds (e.g., the 95^{th} percentile of the predicted future demand). With this strategy, the datacenter operators choose to take no (or very little) risk in losing potential customers or dissatisfying them with less-than-acceptable quality of service.

Such conservative builds increase the datacenter depreciation costs during times when capacity remains unutilized (i.e., no servers are deployed to serve customers). More importantly, such conservative builds require expensive cash-flows. That is, the operators could instead invest the cash corresponding to the unused datacenter capacity in some other product (e.g., another datacenter in an alternative location) and get a corresponding return of investment for that period.

Furthermore, large datacenter operators have a variety of build options. Common examples include lease, dedicated service builds, major collocated spaces, and modular solutions. Each of these option categories has distinct characteristics such as cost, lead times, and time-to-deployment and also power and fiber requirements. Although having many options is appealing since it implies flexibility and adaptability to the location of interest, it creates a combinatorial space of possible options.

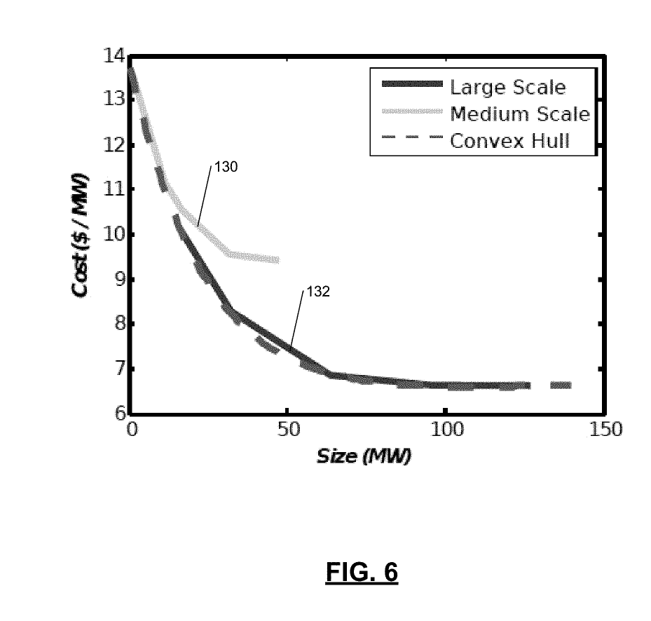

To address the above problems, the systems and methods according to the present disclosure provide a framework for creating low-cost datacenter deployment schedules. An example of a system 90 for planning and building datacenters according to the present disclosure is shown in FIG. 5 and is described below in detail. The system 90 quantifies the risk incurred from uncertain demand and chooses best timing and technology for each datacenter location that minimizes total costs. To minimize cost, the system 90 considers the following problem dimensions: 1) construction costs, 2) operational costs, and 3) depreciation costs. Additionally, the decisions made by the system 90 to build a datacenter (e.g., the datacenter 14 shown in FIG. 1) are subject to availability for land, power, and network infrastructure in the surrounding region.

The system 90 enables buildout planners to take controlled risks. For example, the system 90 suggests building datacenters with capacity less than the traditional deployment capacity, which is generally a high (e.g., 95^{th}) percentile of the demand. By accounting for the risk posed by choosing lower than traditional capacity, the system 90 can wait for tighter prediction bounds to become available, resulting in significantly better decisions in the datacenter size, technology, and deployment timing. Thus, the system 90 improves costs and cash-flows compared to traditional strategies that provision datacenter deployments for the worst-case future demand.

To compensate for the risk, the system 90 models a set of risk management policies which ensure that the capacity demand is fulfilled at any time. These policies include workload-agnostic (e.g., leases) and workload-aware policies (e.g., cooling and power oversubscription, geo-offloading). These policies ensure that the required capacity needed to overcome an unexpected capacity shortfall is made available at any time. The system 90 uses these policies to provision less capacity than the traditionally used worst-case demand scenario. The system 90 can then wait until demand predictions become more robust and reliable.

The system 90 combines all these parameters into a single optimization framework by modelling all the required components. The framework generates a near-to-optimal schedule which strikes a balance between all the modelled tradeoffs. The system 90 creates two classes of schedules: 1) a single-stage schedule, where the generated decisions are taken today; and 2) a two-stage schedule (e.g., a first schedule and a second schedule), where the generated decisions are composed of short-term (here-and-now) decisions (i.e., a first schedule) for a first stage and long-term (deferrable) decisions (i.e., a second schedule) for a second stage. In the second stage, the system 90 schedules for an average case (explained below) that can be re-invoked (i.e., revised, refined, or fine-tuned) in the future when new and more robust predictions become available, without ever falling short of capacity.

Before explaining the system 90 in detail, a brief description of the following is first presented: 1) demand forecasting; 2) capacity planning, construction, scalability; and 3) cost analysis of modern datacenters. Regarding demand forecasting, prior to building a datacenter (e.g., the datacenter 14 shown in FIG. 1), datacenter operators need to estimate the capacity volume for each hosted tenant (i.e., services on that particular location). These estimates can be generated from the following sources: 1) customer volume predictions for all underlying services, 2) corporate agreements (e.g., for a large cloud customer), and 3) opinions from business analysts and other experts. Based on these estimates, datacenter operators use models to derive the expected volume of requests, and translate these requests to server volume and ultimately to datacenter capacity (usually measured in Watts of critical IT infrastructure).

To predict aggregate demand, datacenter operators statistically multiplex the demand predictions for all tenants. Thus, the expected demand and the corresponding confidence bounds are obtained. Statistical multiplexing derives a single stochastic process that describes the future demand for the surrounding region. The system 90 according to the present disclosure uses this prediction to set the minimum deployed capacity at all times and to estimate the risk when a more aggressive scheduling is desired.

Uncertainty in capacity demand can be seen in both low growth and high growth demand scenarios. In either case, early in time (e.g., during months 0-6), datacenter operators tend to have high confidence about expected demand. But the confidence drops fast as the time horizon expands. For example, approximately two years (a typical time for constructing a datacenter at a new location) into the future, datacenter operators have only a rough idea of the demand level.

Regarding capacity planning, datacenter operators currently perform pessimistic builds (i.e., they build according to the 95^{th} percentile of the predicted demand). Datacenter operators follow this strategy to minimize the probability of losing future customers. This strategy, however, greatly overestimates the actual demand, which results in elevated costs.

Regarding datacenter construction, a schematic of typical datacenter architecture is presented in FIG. 4. First, suitable land is acquired. If necessary, power and fiber are brought to the new site. At the same time, a first collocated space is constructed and is equipped with the necessary power, cooling, and networking infrastructure. According to a default capacity planning policy, new collocated spaces will be constructed when demand is predicted to exceed the selected percentile according to the demand distribution.

FIG. 4 shows an example of building a datacenter 100 (e.g., the datacenter 14 shown in FIG. 1). Initially, the operators may plan to build a 64MW datacenter which is deployed in two phases: Phase 1, shown at 102, including the substation, power, and fiber for the whole site, and 32MW of servers (four computer rooms (CR's) each of 8MW); and Phase 2, shown at 104, including a server expansion of 32MW which can be deployed at any time. The cost per MW is drastically high in the first phase since the operators pay for the whole potential site.

Regarding cost analysis, typical total cost of ownership (TCO) of datacenters is dominated by servers (nearly 50%), followed by construction (nearly 25%), energy (nearly 15%), and other costs (10%). The construction costs are dominated by cooling and power (nearly 80%).

FIG. 5 shows an overview of the system 90 for planning and building datacenters (e.g., the datacenter 14 shown in FIG. 1) according to the present disclosure. The system 90 generates low-cost schedules that are suitable for the datacenter demand fulfillment. The underlying workflow of the system 90 is presented in FIG. 5. First, a set of the major cost-driving variables for building a datacenter (e.g., the datacenter 14 shown in FIG. 1) is collected as inputs 110. The inputs 110 include data for construction costs, lead times, energy efficiency, future demand and risk selection, land power and fiber constraints, as well as various datacenter form factors (explained below). In case risk is acceptable, the system 90 models a set of risk-management policies 112 and their associated cost which define the appropriate actions in the event of capacity shortfall.

The set of inputs 110 is provided to a Phase 1 Solver (P1S) 114. The Phase 1 Solver (P1S) 114 comprises a first stage 114-1 and a second stage 114-2. These stages are explained later in more detail. Briefly, based on the inputs 110, the Phase 1 Solver (P1S) 114 constructs an objective (cost) function and a constraint function including linear and nonlinear constraints. The Phase 1 Solver (P1S) 114 analyzes these functions using numerical methods to find an optimal deployment schedule (e.g., a single schedule, or first and second schedules explained below in detail). For example, the Phase 1 Solver (P1S) 114 may use a sequential quadratic programming (SQP) or a genetic algorithm (GA) routine to iterate through the parameter space. SQP performs gradient descent to find global or local minima, but it is sensitive to noise and parameter space deficiencies (e.g., discontinuities and non-convexity). On the other hand, GA is more resilient to these deficiencies, but its probabilistic nature can affect quality of solutions. Nevertheless, both methods solve a continuous problem which may be unrealistic (e.g., building datacenters of an arbitrary size).

Such solutions may be optimal but may not be feasible options for the system 90 since its construction inventory consists of datacenters defined in a form factor set (explained below). Phase 2 Solver (P2S) 116 is responsible for adjusting the solutions from the Phase 1 Solver (P1S) 114 to reflect realistic (i.e., not just optimal but also feasible) construction plans. The Phase 2 Solver (P2S) 116 uses a variation of a Knapsack Problem to find the most cost-effective schedule that is close to the solution provided from the Phase 1 Solver (P1S) 114. In addition, the Phase 2 Solver (P2S) 116 provides a land acquisition recommendation system 90 that aims to minimize the cost of buying land. The Phase 2 Solver (P2S) 116 produces a schedule 118 that specifies the deployment size and type in the future on a periodic basis (e.g., monthly, quarterly, and so on).

The inputs 110 are now explained in detail. Regarding future demand predictions, the system 90 models future demand for resources to build a datacenter (e.g., the datacenter 14 shown in FIG. 1) as a random process. The system 90 uses expected demand for resources and standard deviation for each future point in time (typically a month). The high uncertainty poses a significant constraint in achieving efficient capital investments. Without additional information, operators would build datacenters capable of hosting the worst-case demand (usually assumed to be the 95^{th} percentile) since losing potential customers is undesirable.

Regarding form factors, the system 90 features an extensible table of datacenter types (namely, form factors). The table indicates a list of feasible builds at the location of interest along with important information about their minimum, maximum, and scale units. The table models architectural specifications and requirements among builds for special purposes. For example, hosted workloads may use a variable number of computer rooms (referred to as CR's) to derive their availability. The system 90 utilizes the form factor table together with per-design cost and lead time functions to derive the best schedule under the defined constraints.

For example, the form factor table may offer four options: 1) leased facility suitable for very small deployments, 2) container-based facilities for small to medium deployments, 3) regular builds for medium to large deployments, and 4) hyper-scale builds for very large deployments. Due to uncertain demand, it is challenging to select the combination and timing of options to satisfy the demand with the lowest possible cost.

Regarding construction costs, the optimization procedure needs sufficient knowledge regarding cost for building a datacenter of arbitrary size and technology. The system 90 features a tunable engine that expresses construction costs in terms of dollars per Watt of critical IT infrastructure. The engine uses at least a set of known points for each of the available form factors. The engine performs polynomial regression to find a continuous relationship between the two quantities. Due to the optimization methods employed by the system 90, the resulting function should be pseudo-convex (a function that is not strictly convex but behaves like one for finding its local minima). A cost engine constructs a function convex hull f(x), a maximum concave from the above function that does not exceed the previous interpolated cost functions (or discrete points). The system 90 builds the cost function f(x) by using user-defined form factors. The cost function represents the amount of ($/W) to build the core of a datacenter. An analogous function h(x) is constructed to estimate the shell costs for each category. The system 90 can then calculate the cost for building the first and the rest of phases of the datacenter. By using the functions f(x) and h(x), the system 90 quantifies consequent trade-off between depreciation and economy of scale to produce schedules that will keep the cost as low as possible.

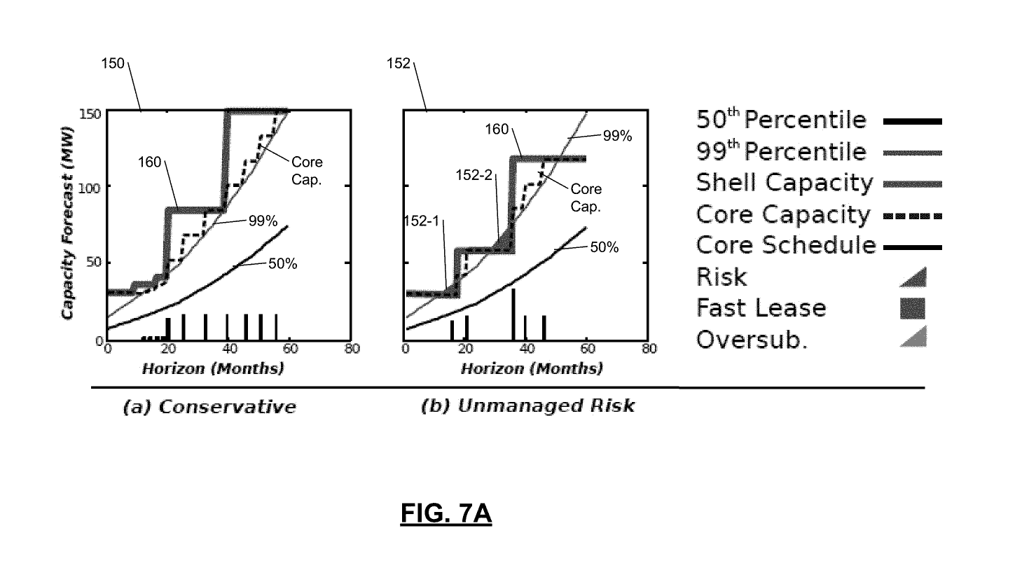

FIG. 6 shows an example process for a single location excluding the fiber, power delivery, and land costs. The grey line 130 shows the cost per MW of scaling a medium-size datacenter from 1 to 48 MW of critical capacity, for example. The black line 132 shows the scaling cost of a large-scale datacenter which scales from 16 to 128 MW, for example. In this scenario, the inventory includes both datacenter technologies, and thus f(x) provides a good approximate best-cost estimate for each size. Although f(x) is continuous, some sizes cannot be physically constructed. The system 90 uses the Phase 2 Solver (P2S) 116 to select feasible construction deployments.

Regarding lead times, to model datacenter lead times, the system 90 uses three functions that relate the datacenter size with the duration of: i) the land selection, ii) the design, and iii) construction. The system 90 uses the above data for each datacenter form factor to construct a single function r(x) which is used from the optimization.

Regarding cost metrics, the objective of the system 90 is to satisfy the future demand with the minimal cost. The system 90 models two cost metrics, namely, 1) today's value, and 2) net present value (NPV), which are used from the objective function in cost calculation. In today's value configuration, the system 90 assumes that one dollar today has the same value as one dollar next year which is unrealistic due to inflation or the possibility of an alternative investment. The system 90 uses net present value (NPV) to model these effects and produces realistic deployment schedules.

Regarding other constraints, land, power, fiber, and lease availability will vary in different regions. It is not uncommon for the maximum datacenter size to be constrained by this availability. Operators are then forced to satisfy the demand with smaller datacenters of higher cost. Thus, the system 90 takes as optional inputs the following attributes: 1) upper and lower bounds, 2) unit of interest and cost per MW, and 3) time varying predictions for their availability (based on forecasts, expert opinions, etc.). Given the above inputs, the system 90 is able to estimate the physical constraints that might arise on each site and thus avoid suggesting unrealistic deployments.

One of the main tasks of the system 90 is to satisfy the aforementioned uncertain capacity demand in the most economical manner. The nature of the demand is uncertain, and the potential customer dissatisfaction is undesirable (either in terms of reduced quality of service or service unavailability). The system 90 therefore models a set of risk management policies (e.g., additional lease or datacenter oversubscription) which are used in the event of capacity shortage. To save costs, the system 90 uses the modelled policies to deploy less datacenter capacity than the pessimistic predictions suggest (e.g., less than 95^{th} percentile). The system 90 then assumes that in case a capacity shortfall is encountered, these policies can be rapidly deployed to make up for the difference. This method saves costs and improves cash-flows since the system 90 can deploy better-timed datacenters. In addition, the system 90 leverages the demand predictions and the datacenter-specific inputs 110 to calculate the probability of a capacity mismatch and the subsequent cost (e.g., a leased datacenter is more expensive than building a private counterpart). This extra cost is then factored in the optimization to find the optimal schedule (a detailed formulation is described below).

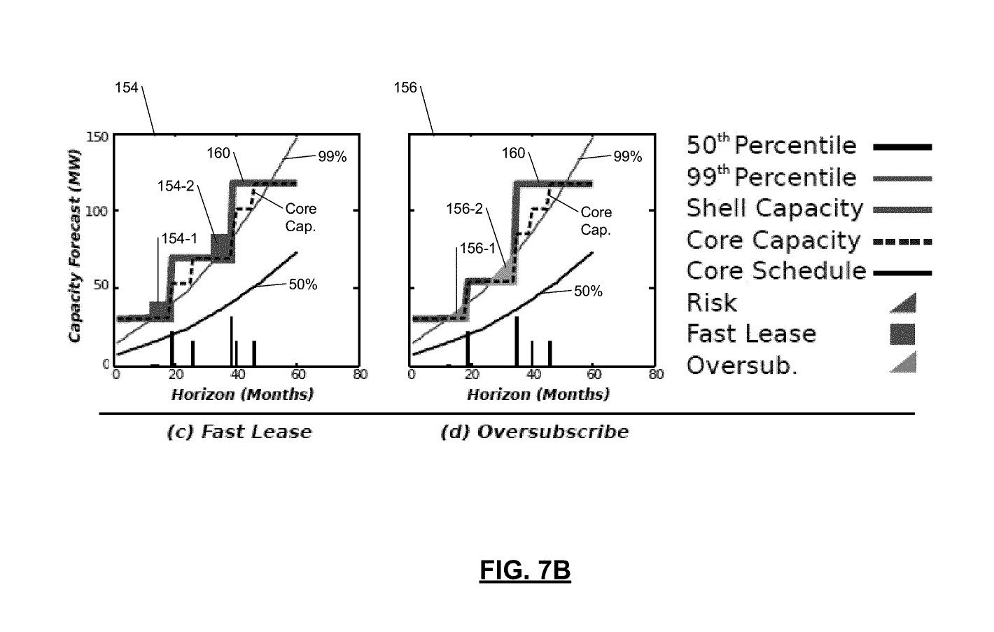

FIGS. 7A and 7B show examples of risk management policies that include the following: conservatively scheduling datacenter deployments, accepting risk (also referred to as unmanaged risk), arranging fast lease, oversubscribing, and geo-multiplexing. Many other options to manage risk are contemplated.

The conservative approach involves scheduling datacenter deployments for the worst-case scenario. This policy incurs the lowest risk of capacity mismatch (depicted in FIG. 7A at 150). Specifically, operators use 99^{th} percentile of the projected demand as a lower bound for the total datacenter capacity on each location. Thus, at each point of time, the deployed capacity is greater than or equal to the demand. As expected, scheduling for the worst-case scenario results in expensive builds that most often depreciate. This policy may incur significantly higher costs when compared to the alternative risk-aware policies that are described below.

A naive method to reduce depreciation and up-front costs is to accept risk (also referred to as unmanaged risk). As illustrated in FIG. 7A at 152, while one can better match the deployed capacity with the expected load, there is a non-zero chance of making a mistake. The possibility of this event is shown at 152-1 and 152-2. Each point in these areas has an associated probability that indicates the chance of the demand being higher than the capacity. During the mismatch events, the only option is to accept the cost of dissatisfying or losing the potential customers, and accounting for that cost by assigning a value to the risk called value at risk (VAR).

To prevent the undesirable customer loss during the events of capacity mismatch, a fast lease policy fulfills the required demand with fast datacenter leases as shown in FIG. 7B at 154. The rectangles 154-1 and 154-2 denote potential leases. The size of these leases is calculated by the maximum mismatch in the vicinity of each event. The selection is made to reflect shortage in leasing facilities (i.e., there is a limited number of potential leases). The fast lease policy also tracks the maximum lease capacity in the area and transforms it into a constraint for the optimization. The optimizer considers the accompanied costs to produce schedules that lease the most cost-effective amount.

Under-provisioning cooling and power infrastructure is an effective measure for reducing datacenter capital costs. Peak server utilization tends to be rare. During these high-utilization periods, datacenters can leverage a set of workload management policies (e.g., power capping, load throttling, request consolidation, etc.) to reduce their power consumption and to prevent over-heating or power over-draw. Under-provisioning can also be viewed as datacenter oversubscription. Whereas under-provisioning aims to lower the datacenter capital costs by deploying lower-than-peak cooling and power capacity, oversubscription allows increased IT capacity to operate under the same power and cooling envelope. Thus, new capacity can be delivered almost instantaneously and is only limited by the server delivery duration.

With this policy, the system 90 can build datacenters with oversubscription capabilities to manage the risk of a potential capacity mismatch. In a manner similar to fast lease, this policy will create low-probability mismatch periods (shown in FIG. 7B at triangles 156-1 and 156-2) that will be tackled with rapid server deployments on an oversubscribed environment. During these periods, the underlying workload might experience lower-than-normal performance during periods of peak outside temperature or server power draw.

After a new datacenter is deployed (shown at 160 in FIGS. 7A and 7B), the oversubscribed servers will be moved in this new deployment. During this process, the underlying workload should be resilient enough to allow its state to be transferred on the fly. This characteristic is present in most online services, which are designed with failure resiliency in mind.

Geo-Multiplexing or statistical multiplexing of shared datacenter resources is a technique used for reducing capital expenses. This policy leverages the increasing datacenter density in different regions to amortize the demand uncertainty. This policy discovers peers in close vicinity of each datacenter (in terms of network latency) and estimates a likelihood of their demands being simultaneously high. Thus, the policy probabilistically guarantees that if the operators are willing to accept risk on some locations, there will be spare capacity with high probability in a peer datacenter that can satisfy the excess demand. The policy aims on moving the excess demand temporarily to the peer datacenter if needed. The rationale is similar to the previous risk-aware policies; operators have the ability to rapidly deploy capacity elsewhere, but with high probability. The equivalent probability is calculated as the likelihood that both stochastic processes will be in a high demand state at each point of time. Also, in the presence of deployed but certainly unused capacity, the scheduler temporarily offers it to its peers.

For example, consider two regions: (a) the US and (b) Asia, with three peer datacenter groups for the US region and one for Asia, in a 1,000 mile radius. In the vicinity of each of the four peer groups, the policy will identify periods of time where the deployed capacity is likely to be unused and will temporarily lend it to its peers if they need it. The policy makes sure that the lent capacity is returned (or freed) before the lending datacenter requires it. During this time, the hosted service will experience higher latency. Accordingly, it is beneficial to migrate the service to the originally planned location when new capacity is eventually deployed on the original site. To perform this migration, the services should feature failover policies, such as transparent state migration to other datacenters and automated re-routing of service requests. Thus, singleton instances of non-replicated workloads are not compatible with this policy.

The formulation of the Phase 1 Solver (P1S) 114 is now explained. First, the formulation that models the datacenter deployment procedure is presented. Then, the formulation for capital, depreciation, and operational costs is shown. Then the single-stage formulation is described, which models a single decision for the entire timespan of the optimization, including five variations of the same formulation that model the various previously presented risk-management policies. Finally, the two-stage formulation is described, which formally accounts for a future alteration to the initial decision made today.

Lex x be a decision vector (or datacenter deployment schedule) where x∈ [symbol] and t be a time index, where t≤n and t∈ [symbol] . Let c∈ [symbol] be a cumulative deployed capacity vector (thus cₜ is the deployed capacity up to time t). To calculate cₜ a buildout vector s can be constructed by utilizing the lead time function r(⋅) as follows:

∀t,cₜ=Σₖ₌₀^{t}s_{┌t}|s_{|t+r(x}_{ₜ}_{)┐}=xₜ for t=1 . . . n (1)

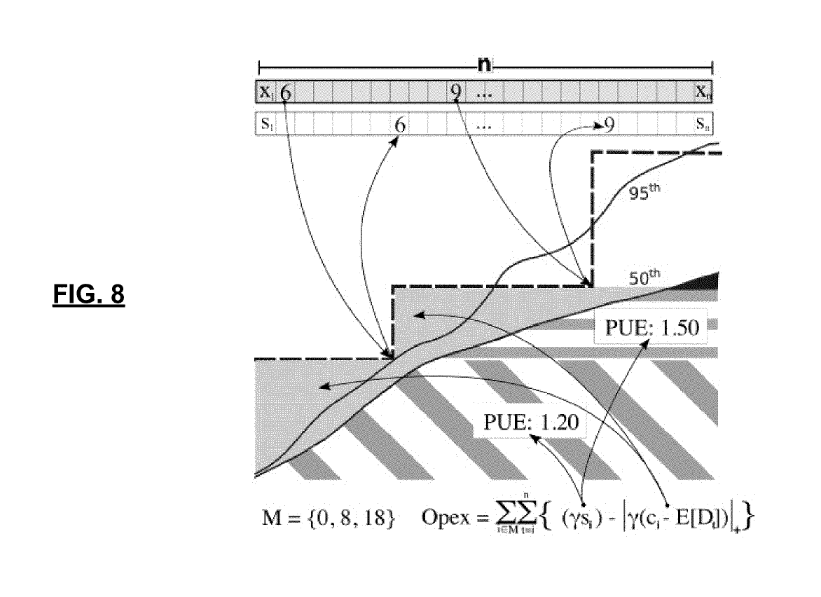

FIG. 8 shows an example where entries of x, s are capacities expressed in MW whereas the dashed line depicts c. In this example scenario, there exists an initial capacity of 8MW; but as the capacity requirements increase, the system 90 quickly (at time x₂) instructs the deployment of a 6MW deployment, which is completed after seven months. Then, at time x₁₀ the system 90 deploys a larger 9MW deployment which is completed after nine months.

To model the future demand, let [symbol] ˜ [symbol] (μ, [symbol] ) be a Gaussian process with mean μ and covariance function K. The Gaussian process is discretized by observing the process at the start of each epoch (total of n samples), which effectively creates a multivariate normal distribution. The Gaussian process is used since it poses a good compromise between simplicity and accuracy. As an alternative, the system 90 can use any continuous or discrete multivariate distribution with well-defined probability density function (PDF) that models the future demand. Here Dₜ denotes sampling [symbol] ₜ at time t, μ is the mean demand, and [symbol] is the covariance function describing the covariance between [symbol] ₜ_{₁} and [symbol] ₜ_{₂}.

To model costs, the following cost functions are defined. Cost functions Capex(x),Depr(x),Opex(x) are defined as the building, depreciation, and operational costs (energy based on peak power usage effectiveness (PUEs)) for a given schedule x as follows:

$$\begin{matrix}Capex ( x ) = {\sum }_{t = 1}^{n} \{ {x}_{t} \cdot f ( {x}_{t} ) + h ( {x}_{t} ) \} & ( 2 ) \\ Depr ( x ) = {\sum }_{i ∈ M} \{ {\sum }_{t = i}^{n} \{ f ( {s}_{i} ) \cdot ( {\vert {c}_{t} - E [ {D}_{t} ] \vert}_{+} ) \} \} & ( 3 ) \\ Opex ( x ) = {\sum }_{i ∈ M} \{ {{\sum }_{t = i}}^{n} \{ ( γ \cdot {s}_{i} ) - {\vert γ \cdot ( {c}_{i} - E [ {D}_{t} ] ) \vert}_{+} \} \} \\ where \text{:} γ = PUE ( {s}_{i} ) \cdot ϵ and M = \{ i \} \vert {s}_{i} > 0 & ( 4 )\end{matrix}$$

Power usage effectiveness (PUE) is a metric used to determine the energy efficiency of a datacenter and is determined by dividing the amount of power entering a datacenter by the power used to run the computer infrastructure within the datacenter.

The above formulation can be interpreted as follows. The capital costs (Eq. 2) are calculated by accounting for the core and shell costs of each individual deployment (the contents of vector (x)). The expected depreciation costs (Eq. 3) are calculated by finding the unused capacity over time. The cost of the unused capacity (the equipment has a predefined lifespan) is modeled as the area over the expected demand, multiplied by the monthly depreciation cost of each capacity unit (unit capacity cost is given by f(⋅)). The expected operational costs (accounting only for energy costs) (Eq. 4) are calculated by calculating the area under the expected demand for each deployment, and over the whole timespan of interest. The operational costs of each deployment are estimated by looking at its corresponding energy efficiency (PUE).

In detail, E[Dₜ] is the expected demand at time t,h(⋅) is the shell cost function, M is a set which holds the times when the deployments are complete, i.e., times when the value of s is not 0, ∈ is the cost of running a deployment of 1 MW for a month (assuming peak PUE for fair comparison between designs), and PUE(xₜ) is the PUE of deployment with size xₜ. FIG. 8 shows a procedure used to calculate the expected operational costs of the whole deployment portfolio via Eq. 4. The example in FIG. 8 shows that to calculate the expected Opex for three deployments (8; 6; 9) with different PUEs (1:20; 1:50; 1:19), the system 90 applies Eq. 4 to find the energy cost based on the expected utilization of these deployments. The system 90 decides the best schedule x for the demand predictions (shown as the 50^{th} and 95^{th} percentiles). Then the system 90 calculates arrays s (shown as an array), c (shown as a dark dashed line), and sets M={0, 8, 18}. Finally, the system 90 applies Eq. 4 as follows. For each deployment (indicated as a member of M), the system 90 sums the expected energy cost per month (which varies, since it is a function of its PUE). The left inner summand calculates the cost of the deployment utilized since its initial deployment (the shaded area under the 50^{th} percentile). The right inner summand calculates the unutilized capacity (the grey solid area above the 50^{th} percentile).

The system 90 has the option to optimize for net present values. In that case, the system 90 replaces Capex(x) by the following term:

$$Capex ( x ) = {\sum }_{t = 1}^{n} ( \frac{{x}_{t} \cdot f ( {x}_{t} ) + h ( {x}_{t} )}{{( 1 + ρ )}^{t}} ) \qquad ( 5 )$$

The above equation is useful in finance, where corporate cash-flows are of the highest importance since they quantify investment opportunities. Specifically, the equation introduces a discount rate that models the varying value of today's cash over time. For example, if a company has the option to invest its cash with a yearly return rate of 10% (ρ=0.1), it is beneficial to delay deployments as much as possible. From the system 90's perspective, the same deployment becomes cheaper as deployment is delayed by leveraging the previously described risk management policies. In the rest of the disclosure, there is no distinction made between the two CAPEX versions. Instead, the operator can decide one of the two available versions (cost or NPV), and the system 90 replaces the definition of Capex(x) accordingly.

The single-stage formulation is now explained in detail. In the single-stage formulation, the system 90 seeks to find a deployment schedule x* that minimizes the total cost today, under a set of constraints, and for the whole timespan of interest. The various risk-management policies outlined previously require alternative definitions of the cost and the constraints functions and are outlined below. Here, the objective functions and constraints for each of these policies are formulated.

The conservative policy finds the optimal schedule x* that minimizes the total cost under minimal risk. For example, Eq. 6 uses a fixed risk (β=0.01). Thus, according to the predictions, at any given point in time, there exists at most 1% chance of encountering higher demand than the deployed capacity. Further constraints include bounds for the deployment size as defined in the form factor table, and upper bounds for the land, power, and network availability in the location according to predictions. The formulation follows an optimization notation. First, the objective function (i.e., the function sought to be minimized) is presented, followed by the constraints. The system 90 then minimizes each objective function by using the previously outlined numerical methods. The first objective function is as follows:

$${x}^{*} = {arg min}_{x} \{ Capex ( x ) + Depr ( x ) + Opex ( x ) \} \\ subject to \text{:} ∀ t , {c}_{t} \geq {F}_{{D}_{t}}^{- 1} ( 1 - β ) \\ {P}_{t} \leq {F}_{{P}_{t}}^{- 1} ( 1 - β ) {f}_{t} \leq {F}_{{F}_{t}}^{- 1} ( 1 - β ) \\ min \leq {x}_{t} \leq max \\ {x}_{1} = initCap \qquad ( 6 )$$

Here, F_{D}_{ₜ}⁻¹(⋅) is a quantile function (or inverse cumulative distribution function) which corresponds to the demand process D observed at times t=1 . . . n. Next, Pₜ and fₜ model the power and fiber at any time t whereas F_{P}_{ₜ}⁻¹ and F_{F}_{ₜ}⁻¹ correspond to quantile functions of underlying random processes P, F that govern power and fiber availability in the location of interest. The above two constraints are useful in cases where the deployment uses the grid as its power source and the public network for connectivity. In cases where power and fiber can be brought to the site (and doing so is financially feasible), the above constraints model the delivery dates (that may also be subject to uncertainty). Note that the system 90 features an extra land constraint which is identical to the power and fiber constraints but is omitted in the formulas and text for brevity. Finally, the terms min, max denote the minimum and maximum allowable deployment size, while initCap is the capacity which is already deployed (or scheduled to be deployed in the near future).

The unmanaged risk policy is similar to the conservative policy. The major difference is the ability to manually specify the lower capacity bound. A bound vector b, b∈ [symbol] is defined as the maximum quantile violation of demand (e.g., if bₜ=0.05, the deployed capacity at time t cannot be lower than the 95^{th} percentile of the demand). Due to the aforementioned similarities with the previous policy, only the first constraint of Eq. 6 is modified to:

∀t,cₜ≥F_{D}_{ₜ}⁻¹(1−bₜ)

The fast lease policy extends the previous policy by adding a probabilistic lease term to the cost function. Thus, the minimized expression re-forms as:

$$\begin{matrix}{x}^{*} = {arg min}_{x} \{ Capex ( x ) + Depr ( x ) + Opex ( x ) + {\sum }_{t = 1}^{n} ( E [ {l}_{t} ] ) \} \\ subject to \text{:} ∀ t , {c}_{t} \geq {F}_{{D}_{t}}^{- 1} ( 1 - {b}_{t} ) \\ {P}_{t} \leq {F}_{{P}_{t}}^{- 1} ( 1 - β ) {f}_{t} \leq {F}_{{F}_{t}}^{- 1} ( 1 - β ) \\ min \leq {x}_{t} \leq max \\ {x}_{1} = initCap & ( 7 ) \\ ∀ t , {1}_{t} \leq {F}_{{L}_{t}}^{- 1} ( β ) & ( 8 )\end{matrix}$$

Here, 1∈ [symbol] is a leased capacity vector. Its individual elements 1ₜ are defined as maximum (potential) capacity shortage which will occur until next deployment. Furthermore, l is a corresponding lease cost vector, and F_{L}_{ₜ}⁻¹(β) is an upper bound on the lease availability estimated from the lease availability predictions. Note that F_{L}_{ₜ}⁻¹(β) uses β and not (1−β). This models an intention to be pessimistic on the lease availability predictions (i.e., schedule based on a very conservative availability scenario).

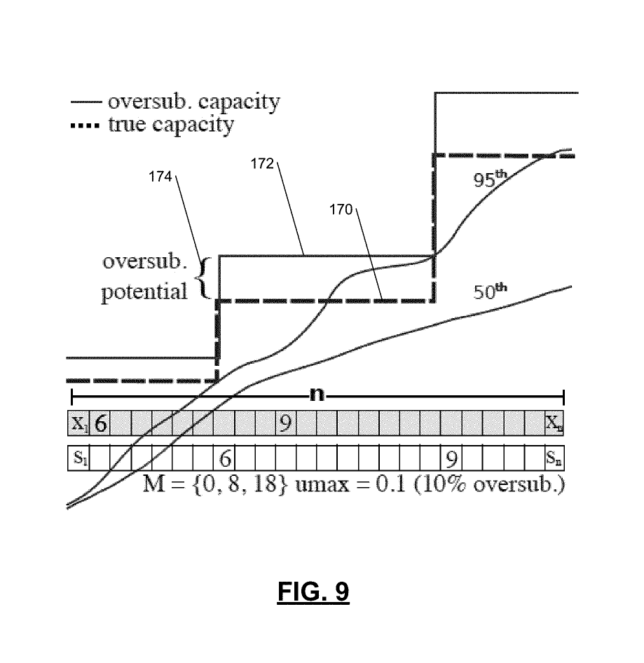

The oversubscription policy replaces the probabilistic lease term l by u∈ [symbol] to model the cost for oversubscribing the deployments. The maximum oversubscription capability is limited by umax∈ [symbol] which is a fixed scalar that denotes the maximum oversubscription (e.g., 10% of the total capacity). FIG. 9 shows an example of the future demand predictions and three deployments of 8, 6, and 9 MW each (shown with a dashed line 170). By considering the total capacity that can be achieved with oversubscribing the deployments (shown with a solid line 172), the system 90 is able to build lower capacity than the 95^{th} percentile of the future demand. In case that demand turns out to be higher, operators can oversubscribe the existing deployments (shown as oversubscribing potential 174) to correct the previous decisions and make up for any capacity shortfall.

$$\begin{matrix}{x}^{*} = {arg min}_{x} \{ Capex ( x ) + Depr ( x ) + Opex ( x ) + {\sum }_{t = 1}^{n} ( E [ {u}_{t} ] ) \} \\ subject to \text{:} ∀ t , {c}_{t} \geq {F}_{{D}_{t}}^{- 1} ( 1 - {b}_{t} ) \\ {P}_{t} \leq {F}_{{P}_{t}}^{- 1} ( 1 - β ) {f}_{t} \leq {F}_{{F}_{t}}^{- 1} ( 1 - β ) \\ min \leq {x}_{t} \leq max \\ {x}_{1} = initCap & ( 9 ) \\ ∀ t , {u}_{t} \leq ( {c}_{t} \cdot u max ) \vert {u}_{t} = {\vert {F}_{{D}_{t}}^{- 1} ( 1 - β ) - {c}_{t} \vert}_{+} & ( 10 )\end{matrix}$$

In Eq. 10, u∈ [symbol] is an oversubscription vector, and u is a corresponding cost vector. The constraint which regulates the use of oversubscription calculates the area where cₜ is above a high percentile of the demand Dₜ. Then it compares this area with the current oversubscription capability. As shown in the example in FIG. 9, the third deployment is intentionally scheduled late by the system 90, and there is a maximum (potential) shortage of 1.4 MW which will temporarily be handled by oversubscribing the previous deployments.

Regarding the geo-distribution policy, a high-level description of how geo-multiplexing can improve costs is previously presented. Here, an equivalent formulation is presented. The purpose of the geo-distribution policy is to minimize the total costs of a super-region S. Here, {D₀ . . . Dₖ₋₁}∈S are the datacenter locations that belong to the super-region. In this context, Dᵢ is a demand prediction (multivariate normal distribution) for a location of an i^{th} datacenter. In case Dᵢ follows a normal distribution, the total demand for the super-region T=D₀+D₁+ . . . +Dₖ₋₁ follows a normal distribution as well, as illustrated in Eq. 11 (μᵢ and Kᵢ correspond to the means and covariance matrices of the demand distributions). The summation of two normally distributed random vectors follows a multivariate normal distribution when the underlying processes are independent (in other words when their cross-covariance is zero).

In any other case, the system 90 numerically convolutes the individual Dᵢ's to obtain the distribution of T.

$$T = {\sum }_{i = 0}^{k - 1} {D}_{i} ∼ ( {\sum }_{i = 0}^{k - 1} {μ}_{i} , {\sum }_{i = 0}^{k - 1} {K}_{i} ) \qquad ( 11 )$$

The actual optimization procedure simultaneously considers the decisions for each datacenter in the super-region. Thus, the previously defined vector x∈ [symbol] ^{k×n} (and consequently, vectors c, s) is modified to include all the decisions for the datacenter members of the super-region S.

$${\vec{[ \begin{matrix}{x}_{0 , 1} & {x}_{0 , 2} & {x}_{0 , 3} & … & {x}_{0 , n} \\ {x}_{1 , 1} & {x}_{1 , 2} & {x}_{1 , 3} & … & {x}_{1 , n} \\ ⋮ & ⋮ & ⋮ & ⋱ & ⋮ \\ {x}_{k - 1 , 1} & {x}_{k - 1 , 2} & {x}_{k - 1 , 3} & … & {x}_{k - 1 , n}\end{matrix} ]}}^{Time} ( 12 )$$

The objective function then becomes:

$${x}^{*} = {arg min}_{x} {{\sum }_{i = 0}}^{k - 1} Φ ( {x}_{i} ) \\ subject to \text{:} ∀ t , {\sum }_{i = 0}^{k - 1} {c}_{ij} \geq {F}_{{T}_{t}}^{- 1} ( α ) \qquad ( 13 )$$

Here, Φ is any objective function that was previously defined in Eqs. 6-10. Next, xᵢ denotes an i^{th} row of a decision matrix xᵢ that corresponds to a deployment schedule for the equivalent datacenter. Furthermore, F_{T}⁻¹(α) is the quantile function of the random vector T that was previously defined in Eq. 11 while T is the user-selected quantile.

The objective function presented above (Eq. 14) tries to minimize the total cost of all the datacenters in the super-region. The single constraint simply states that the aggregate capacity in the super-region (the summation of all datacenters at each point in time) should be greater than or equal to the capacity which corresponds to the selected quantile a of the aggregate demand T. The remaining constraints which are paired with their corresponding objective functions are not presented for brevity.

The two-stage formulation is now presented. In the single-stage formulation, a deterministic method is formulated to find a minimum-cost deployment schedule x* by considering the uncertain capacity demand D. Since the system 90 is designed for long-term planning, it is unrealistic to assume that no future decisions will be made to correct today's over- or under-estimations due to high uncertainty in future demand. One possible option is to re-solve the deterministic version of the problem in the future (e.g., after 6 months) by initializing the new instance of the problem with the decisions of the previous epoch (0-6 months) that cannot be altered. It is difficult, however, to estimate the overall decision quality, which can become poor due to lack of coordination between re-runs of the solver.

A formal solution to the above problem is the introduction of recourse actions in a two-stage stochastic programming formulation. Recourse actions (not to be confused with the risk-aware policies) are possible future alterations to the initial decision vector x* to adapt to new demand information which is revealed as time progresses. The two-stage stochastic programming seeks today's (present) best decision by considering the expected cost of tomorrow's (future) second-stage decision (recourse action) given the decision of the first stage. With this approach, the system 90 allows deployments to be deferred, as long as the formulation can guarantee that enough capacity can be deployed in time, if a single alteration is allowed to the initial decision taken at time t=1. The objective function is now modified as follows.

$${x}^{*} = {arg min}_{x} \{ Φ ( x ) + E [ Q ( x , ξ ) ] \} \\ subject to \text{:} Θ ( x ) \vert β = 0.05 , n = p \\ Q ( x , ξ ) = {min}_{y} \{ q ( , ξ ) \vert x \} \\ subject to \text{:} Θ ( ) \vert P ( D = {ξ}^{k} ) = 1 , n = m \\ initCap = {\sum }_{t = 1}^{p} {x}_{t} \qquad ( 14 )$$

where ∠(x), Θ(x) correspond to one of the previous objectives and the corresponding non-linear constraint functions defined in Eqs. 6-10, [symbol] corresponds to the second-stage decision vector, and ξ∈D is the set of all possible realizations on the second-stage.

Eq. 14 can be interpreted as follows. First, it is decided when it is best to split the problem into two phases by setting p and m. Then, the first minimization problem is solved. Initially, the demand of the first stage (which is usually short in duration and tight in confidence) is set as a fixed, high percentile of D. Then, the minimum of the function Φ(x), (for n=p) plus the expectation of Q(x,ξ), a which is the cost of the second stage sub-problem, is computed. Any (modified) constraints defined among the objective function are honored (by summarizing all constraints with function Θ(x)=0). Then, Q(x,ξ) can be interpreted as follows. Given a decision x for t=1 . . . p, the minimum-cost decision [symbol] is found, assuming that the demand will follow a deterministic particular realization (namely, ξ^{k}∈D) from t=p+1 . . . m. To accurately capture the expectation of Q(x,ξ), a the same procedure is performed with all possible ξ (i.e., all possible realization of D). Thus, multiple sub-problems for every choice of x are solved.

The computational effort in the above formulation lies now in the computation of E[Q(x,ξ)] since the number of possible realizations of D in the second stage is infinite (recall that D is modeled as a continuous random process). A Monte-Carlo approach is adopted to reduce the second-stage outcomes of D. Specifically, a Sample Average Approximation (SAA) method is used. SAA approximates the true expectation E[Q(x,ξ)] with q̂N by repeatedly averaging a series of random N sample realizations from D, ξ¹ . . . ξ^{N} as follows.

$$\hat{Q} ( x , ξ ) = \frac{1}{N} {\sum }_{k = 1}^{N} Q ( x , {ξ}^{k} ) \qquad ( 15 )$$

Then Eq. 14 becomes:

$${x}^{*} = {arg min}_{x} \{ Φ ( x ) + \frac{1}{N} {\sum }_{k = 1}^{N} Q ( x , {ξ}^{k} ) \} \qquad ( 16 )$$

subject to: prev. defined constraints

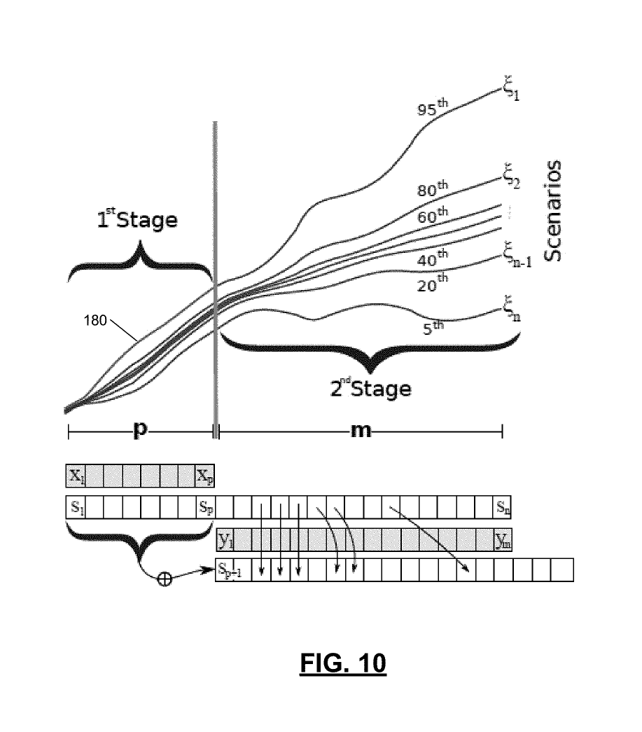

FIG. 10 illustrates an example of the above method with some possible realizations and their corresponding probabilities. At t=1 the system 90 makes a decision for the period t=1 to t=p. Therefore, the system 90 adopts a pessimistic approach and schedules builds assuming the true demand is equal to the 95^{th} percentile (shown in FIG. 10 at 180). Note that as explained above, the optimizer is still free to take further risks because it ensures that the demand can be met regardless of the actual demand realization. To obtain the best decision x* the system 90 calculates the expectation of Q(x,ξ) by using the previously mentioned SAA method over N samples of the second stage (ξ^{N}). This equation requires that the initial capacity of the second stage program equals to the deployed capacity of the first stage. As shown in FIG. 10, some builds that were deployed during the first stage cannot be altered, while others might be deferred according to the scenario requirements.

The Phase 2 Solver (P2S) 116 shown in FIG. 5 is now described in detail. The Phase 2 Solver (P2S) 116 adapts the optimal schedule x* to the available technology solutions and internal requirements. Recall that x* was previously produced by the Phase 1 Solver (P1S) 114 based on continuous approximations of the cost and lead times (convex hull). The goal of the Phase 2 Solver (P2S) 116 is to minimize the cost of creating realistic schedules \hat{x}* that are as close as possible to the optimal (but probably infeasible) solution x*. The Phase 2 Solver (P2S) 116 alters Knapsack's objective function to minimize the cost of each entry of x* that has at least the same capacity as x*. The same risk derived by the Phase 1 Solver (P1S) 114 can be maintained, and the same cost estimates for the risk mitigation policies can be extended.

Now consider deploying λ categories, which are defined in the form factor table. Define a set U={σ₁ . . . σ_{λ}} to be the scale units of each category, and C={f₁(⋅) . . . f_{λ}(⋅)} as the equivalent cost functions. Suppose now that in the same datacenter one can deploy only some of these categories together (i.e., some deployments are technologically incompatible). Define a compatibility (or feasibility) set G={U_{k∈μ}K . . . U_{j∈ν}J} where set indices 0≤μ, ν≤λ are user-defined. The user-defined set indices point to the deployment categories. The union operation merges the compatible deployments into sets K . . . J which are accounted in the core of the Phase 2 Solver (P2S) 116. Then, the core of the Phase 2 Solver (P2S) 116 performs the following iteration to produce the approximate schedule \hat{x}*:

for t=1 . . . n (17)

<\hat{x}*,rₜ>=K̅S̅(\hat{x}ₜ*,G,U,C)

\hat{x}ₜ₊₁*−=rₜ (18)

Here, K̅S̅(⋅,⋅,⋅,⋅) denotes the invocation of the modified Knapsack version explained above, given the total capacity for each deployment \hat{x}ₜ*; and G, the compatibility set which is user-defined. rₜ is the residual capacity after the invocation of K̅S̅ at each time t. The residual is subtracted from the next time slot of \hat{x}*, so the next iteration accounts for the excess capacity of time t.

Thus, the system 90 is a datacenter deployment optimization framework. The system 90 accepts as inputs the technical specifications of the possible datacenter fleet (noted previously as the form factor table). Then, the system 90 uses an optimization framework to create a near-optimal deployment schedule. The system 90 also uses the uncertain demand and a selection of risk-management policies to take quantified risks. In case of capacity shortfalls, the system 90 uses these policies to guarantee capacity will always be available. The system 90 provides a sophisticated model to describe the future demand. The system 90 quantifies and allows controlled risk. The system 90 can mitigate that risk with a set of state-of-the-art management techniques such as fast leases, power and cooling oversubscription, and geo-offloading. The system 90 is then able to better match the deployed capacity with the actual demand. The system 90 sets all of the above to a formal mathematical framework that generates a close-to-optimal, feasible schedule for given a set of inputs.

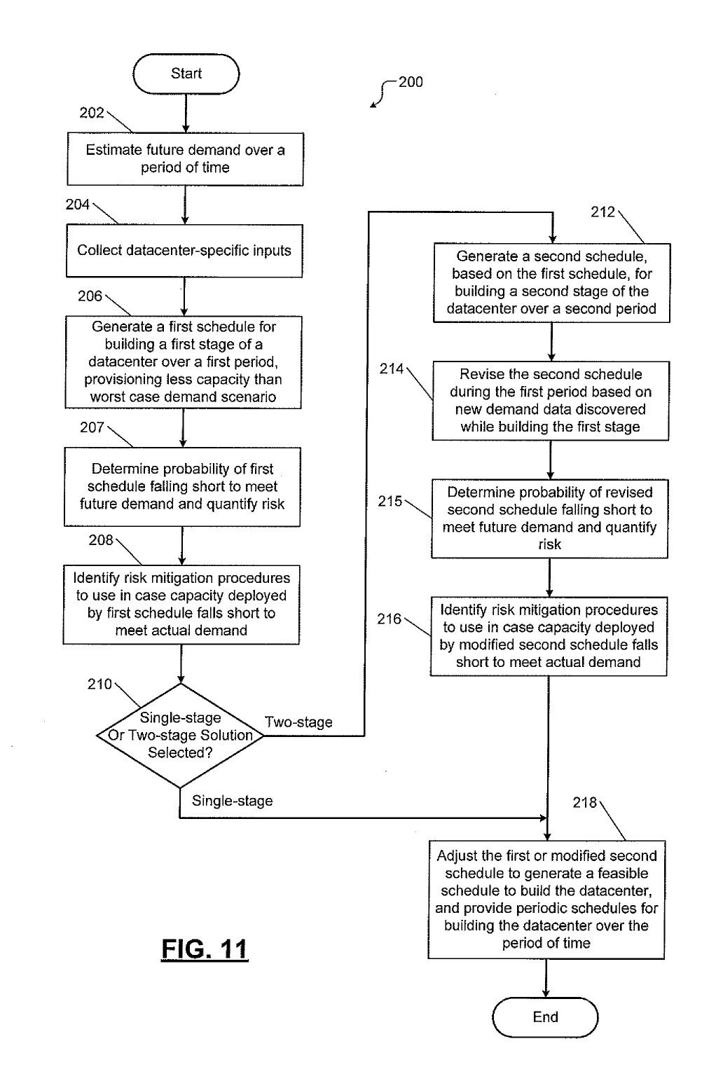

FIG. 11 shows a method 200 for building a datacenter (e.g., the datacenter 14 shown in FIG. 1) according to the present disclosure. In the following description, the term control refers to one or more of the client and server applications 366 and 386 described below with reference to FIGS. 12-14, which implement the system 90 described above and the method 200 described below. In other words, the term control represents code or instructions executed by one or more components of the cloud computing system 10 shown in FIGS. 1-3 or by one and/or more components of the distributed network system 300 shown in FIGS. 12-14 to perform the described functionality.

At 202, control estimates future demand for resources over a period of time to build a datacenter. For example, control estimates the future demand based on factors including but not limited to prediction of services to be provided to tenants by the datacenter, agreements with tenants, and opinions of business analysts and experts regarding the future demand. For example, the resources to build the datacenter comprise construction resources including land, power, and network infrastructure to construct the datacenter, and computing resources including computing devices (e.g., servers, storage, etc.) for the datacenter.

At 204, control collects datacenter specific inputs. For example, the inputs include but are not limited to construction costs (e.g., capital, depreciation, and operating costs); lead times associated with land selection, design, and construction; energy efficiency (i.e., power usage effectiveness (PUE)); the future demand and risk selection; form factors for the datacenter (e.g., size and type of datacenter including but not limited leased, container-based, regular, and hyper-scale datacenters); and constraints regarding land, power, and network infrastructure. At 206, control generates a first schedule for building a first stage of the datacenter over a first period, provisioning less capacity than the capacity needed to fulfill worst-case demand scenario.

At 207, control determines a probability of the first schedule falling short (i.e., resources according to the first schedule being insufficient) to meet the future demand and quantifies the risk associated with the first schedule. At 208, control identifies risk mitigation procedures to use in case the capacity deployed by the first schedule falls short to meet actual demand. For example, the risk mitigation procedures include but are not limited to oversubscribing resources in the first schedule, lending a portion of the future demand to a peer datacenter, and leasing an additional datacenter; or optionally, not taking any risk by conservatively provisioning the capacity needed to fulfill worst-case demand scenario (e.g., 95^{th} percentile).

At 210, control determines whether a single-stage solution or two-stage solution is selected for building the datacenter. At 212, if a two-stage solution is selected, control generates a second schedule based on the first schedule for building a second stage of the datacenter over a second period that follows the first period. The second schedule is an average of a plurality of schedules of resources generated for different percentages of the future demand (see FIG. 10).

At 214, control revises (i.e., refines or improves) the second schedule during the first period based on new demand information discovered while building the first stage of the datacenter. At 215, control determines a probability of the modified second schedule falling short (i.e., resources according to the modified second schedule being insufficient) to meet the future demand and quantifies the risk associated with the modified second schedule. At 216, control identifies risk mitigation procedures to use in case the capacity deployed by the modified second schedule falls short to meet actual demand.

At 218, after 216 or if selection of a single-stage solution for building the datacenter is confirmed at 210, control adjusts the first schedule or the modified second schedule to generate a feasible schedule to build the datacenter most economically and provides periodic (e.g., monthly) schedules for building the datacenter over the period of time.

Below are simplistic examples of a distributed computing environment in which the systems and methods of the present disclosure can be implemented. Throughout the present disclosure, references to terms such as servers, client devices, applications, and so on are for illustrative purposes only. The terms servers and client devices are to be understood broadly as representing computing devices comprising one or more processors and memory configured to execute machine readable instructions. The terms applications and computer programs are to be understood broadly as representing machine readable instructions executable by the computing devices.

FIG. 12 shows a simplified example of a distributed network system 300. The distributed network system 300 includes a network 310, one or more client devices 320-1, 320-2, . . . , and 320-M, and one or more servers 330-1, 330-2, . . . , and 330-N (collectively servers 330), where M and N are an integers greater than or equal to one. The network 310 may include a local area network (LAN), a wide area network (WAN) such as the Internet, or other type of network (collectively shown as the network 310). The client devices 320 communicate with the servers 330 via the network 310. The client devices 320 and the servers 330 may connect to the network 310 using wireless and/or wired connections to the network 310.

The servers 330 and the client devices 320 may implement one or more components of the cloud computing system 10 shown in FIGS. 1-3. For example, one server 330 may implement the cloud controller 12 or the compute resource provider 26 of the cloud controller 12 while one or more client devices 320 may implement the fabric controllers 32. Alternatively, one or more servers 330 may implement one or more components of the cloud controller 12. Many different configurations of implementations are contemplated.

The servers 330 may provide multiple services to the client devices 320. For example, the servers 330 may execute a plurality of software applications. The servers 330 may host multiple databases that are utilized by the plurality of software applications and that are used by the client devices 320. In addition, the servers 330 and the client devices 320 may execute applications that implement the system 90 and the method 200 for building datacenters described above.

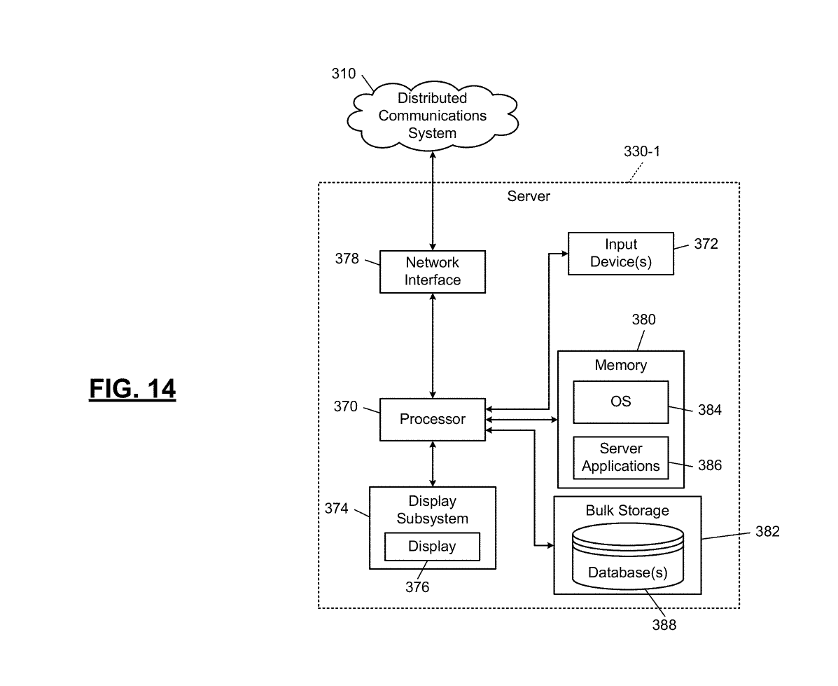

FIG. 13 shows a simplified example of the client devices 320 (e.g., the client device 320-1). The client device 320-1 may typically include a central processing unit (CPU) or processor 350, one or more input devices 352 (e.g., a keypad, touchpad, mouse, and so on), a display subsystem 354 including a display 356, a network interface 358, a memory 360, and a bulk storage 362.

The network interface 358 connects the client device 320-1 to the distributed network system 300 via the network 310. For example, the network interface 358 may include a wired interface (e.g., an Ethernet interface) and/or a wireless interface (e.g., a Wi-Fi, Bluetooth, near field communication (NFC), or other wireless interface). The memory 360 may include volatile or nonvolatile memory, cache, or other type of memory. The bulk storage 362 may include flash memory, a hard disk drive (HDD), or other bulk storage device.

The processor 350 of the client device 320-1 executes an operating system (OS) 364 and one or more client applications 366. The client applications 366 include an application to connect the client device 320-1 to the servers 330 via the network 310. The client device 320-1 accesses one or more applications executed by the servers 330 via the network 310. The client applications 366 may also include an application that implements the system 90 and the method 200 for building datacenters described above.

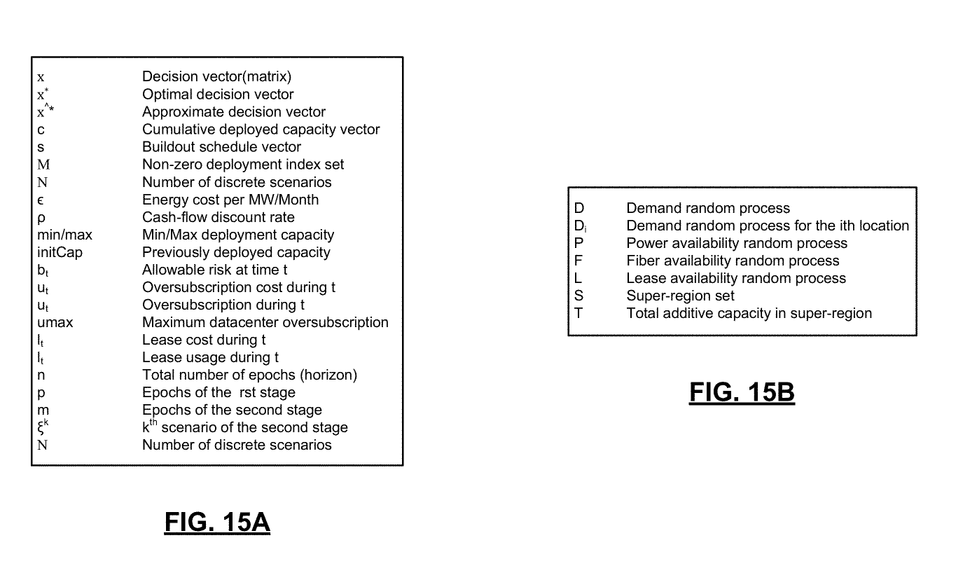

FIG. 14 shows a simplified example of the servers 330 (e.g., the server 330-1). The server 330-1 typically includes one or more CPUs or processors 370, one or more input devices 372 (e.g., a keypad, touchpad, mouse, and so on), a display subsystem 374 including a display 376, a network interface 378, a memory 380, and a bulk storage 382.

The network interface 378 connects the server 330-1 to the distributed network system 300 via the network 310. For example, the network interface 378 may include a wired interface (e.g., an Ethernet interface) and/or a wireless interface (e.g., a Wi-Fi, Bluetooth, near field communication (NFC), or other wireless interface). The memory 380 may include volatile or nonvolatile memory, cache, or other type of memory. The bulk storage 382 may include flash memory, one or more hard disk drives (HDDs), or other bulk storage device.

The processor 370 of the server 330-1 executes an operating system (OS) 384 and one or more server applications 386. The server applications 386 may include an application that implements the system 90 and the method 200 for building datacenters described above. The bulk storage 382 may store one or more databases 388 that store data structures used by the server applications 386 to perform respective functions.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

What is claimed is:

1. A system comprising:
a processor; and
machine readable instructions, stored on a tangible machine readable medium, when executed by the processor, configure the processor to:
estimate, using a model, a future demand for resources over a period of time to build a datacenter, the resources comprising construction resources including land, power, and network infrastructure to construct the datacenter and computing resources including computing devices for the datacenter, and the period of time including a first time period followed by a second time period;
generate, using the model, based on inputs including the future demand, a first schedule of resources to build a first stage of the datacenter over the first time period, the first schedule including fewer resources than an amount of resources capable of fulfilling the future demand;
determine, using the model, a probability of the first schedule not fulfilling the future demand;
determine, using the model, a risk associated with the first schedule based on the probability;
identify one or more procedures to employ to mitigate the risk, the procedures including oversubscribing resources in the first schedule, lending a portion of the future demand to a peer datacenter, and leasing an additional datacenter;
generate, based on the first schedule, a second schedule of resources to build a second stage of the datacenter over the second time period, the second schedule being an average of a plurality of schedules of resources generated for different percentages of the future demand using the model; and
modify the second schedule during the first time period based on demand information discovered while building the first stage of the datacenter during the first time period to minimize cost of building the datacenter.

2. The system of claim 1 wherein the machine readable instructions configure the processor to minimize the cost of building the datacenter by minimizing capital costs, depreciation costs, operating costs associated with building the datacenter according to the first schedule, the modified second schedule, and the one or more procedures to mitigate the risk.

3. The system of claim 1 wherein the machine readable instructions configure the processor to:
adjust one or more of the first and second schedules to provide a recommendation for land acquisition and construction planning to minimize the cost of building the datacenter; and
generate a periodic schedule specifying amounts of resources to be deployed over sub-periods of the period of time while building the datacenter over the period of time.

4. The system of claim 1 wherein the machine readable instructions configure the processor to:
determine, using the model, a second probability of the second schedule or the modified second schedule not fulfilling the future demand;
determine, using the model, a second risk associated with the second schedule or the modified second schedule based on the second probability; and
identify the one or more procedures to employ to mitigate the second risk.

5. The system of claim 1 wherein the model is configured to estimate the future demand based on prediction of services to be provided to tenants by the datacenter, agreements with tenants, and opinions of business analysts and experts regarding the future demand.

6. The system of claim 1 wherein the inputs include:
construction costs;
lead times associated with land selection, design, and construction;
energy efficiency;
the future demand and risk selection;
form factors for the datacenter; and
constraints regarding land, power, and network infrastructure.

7. A system comprising:
a processor; and
machine readable instructions, stored on a tangible machine readable medium, when executed by the processor, configure the processor to:
estimate, using a model, a future demand for resources over a first time period to build a datacenter, the resources comprising construction resources including land, power, and network infrastructure to construct the datacenter and computing resources including computing devices for the datacenter;
generate, using the model, based on inputs including the future demand, a first schedule of resources to build a first stage of the datacenter over the first time period, the first schedule including fewer resources than an amount of resources capable of fulfilling the future demand;
determine, using the model, a probability of the first schedule not fulfilling the future demand;
determine, using the model, a risk associated with the first schedule based on the probability; and
identify one or more procedures to employ to mitigate the risk, the procedures including oversubscribing resources in the first schedule, lending a portion of the future demand to a peer datacenter, and leasing an additional datacenter, wherein the first schedule and the one or more procedures minimize cost of building the datacenter.

8. The system of claim 7 wherein the machine readable instructions configure the processor to generate, based on the first schedule, a second schedule of resources to build a second stage of the datacenter over a second time period following the first time period, the second schedule being an average of a plurality of schedules of resources generated for different percentages of the future demand using the model.

9. The system of claim 8 wherein the machine readable instructions configure the processor to modify the second schedule during the first time period based on demand information discovered while building the first stage of the datacenter during the first time period.

10. The system of claim 8 wherein the machine readable instructions configure the processor to:
adjust one or more of the first and second schedules to provide a recommendation for land acquisition and construction planning to minimize the cost of building the datacenter; and
generate a periodic schedule specifying amounts of resources to be deployed over sub-periods of the first and second time periods while building the datacenter over the first and second time periods.

11. The system of claim 8 wherein the machine readable instructions configure the processor to:
determine, using the model, a second probability of the second schedule or the modified second schedule not fulfilling the future demand;
determine, using the model, a second risk associated with the second schedule or the modified second schedule based on the second probability; and
identify the one or more procedures to employ to mitigate the second risk.

12. The system of claim 7 wherein the model is configured to estimate the future demand based on prediction of services to be provided to tenants by the datacenter, agreements with tenants, and opinions of business analysts and experts regarding the future demand.

13. The system of claim 7 wherein the inputs include:
construction costs;
lead times associated with land selection, design, and construction;
energy efficiency;
the future demand and risk selection;
form factors for the datacenter; and
constraints regarding land, power, and network infrastructure.

14. A method comprising:
estimating a future demand for resources over a first time period to build a datacenter, the resources comprising construction resources including land, power, and network infrastructure to construct the datacenter and computing resources including computing devices for the datacenter;
generating based on inputs including the future demand, a first schedule of resources to build a first stage of the datacenter over the first time period, the first schedule including fewer resources than an amount of resources capable of fulfilling the future demand;
determining a probability of the first schedule not fulfilling the future demand;
determining a risk associated with the first schedule based on the probability; and
identifying one or more procedures to employ to mitigate the risk, the procedures including oversubscribing resources in the first schedule, lending a portion of the future demand to a peer datacenter, and leasing an additional datacenter, wherein the first schedule and the one or more procedures minimize cost of building the datacenter.

15. The method of claim 14 further comprising generating, based on the first schedule, a second schedule of resources to build a second stage of the datacenter over a second time period following the first time period, the second schedule being an average of a plurality of schedules of resources generated for different percentages of the future demand.

16. The method of claim 15 further comprising modifying the second schedule during the first time period based on demand information discovered while building the first stage of the datacenter during the first time period.

17. The method of claim 15 further comprising:
adjusting one or more of the first and second schedules to provide a recommendation for land acquisition and construction planning to minimize the cost of building the datacenter; and
generating a periodic schedule specifying amounts of resources to be deployed over sub-periods of the first and second time periods while building the datacenter over the first and second time periods.

18. The method of claim 15 further comprising:
determining a second probability of the second schedule or the modified second schedule not fulfilling the future demand;
determining a second risk associated with the second schedule or the modified second schedule based on the second probability; and
identifying the one or more procedures to employ to mitigate the second risk.

19. The method of claim 14 further comprising estimating the future demand based on prediction of services to be provided to tenants by the datacenter, agreements with tenants, and opinions of business analysts and experts regarding the future demand.

20. The method of claim 14 wherein the inputs include:
construction costs;
lead times associated with land selection, design, and construction;
energy efficiency;
the future demand and risk selection;
form factors for the datacenter; and
constraints regarding land, power, and network infrastructure.
